(19) United States
(12) Patent Application Publication
(10) Pub. No.: US 2003/0000139 A1
(43) Pub. Date: Jan. 2, 2003

(54) Mesh-backed lawn sod and apparatus for producing the same

(76) Inventor: James Lars Anderson, West Jordon, UT (US)

Correspondence Address: James Lars Anderson, 7976 South 3685 West, West Jordan, UT, 84088, US

(21) Appl. No.: 09/894,575

(22) Filed: Jun. 28, 2001

(51) Int. Cl. A01C 1/04

(52) U.S. Cl. 47/56

(57) ABSTRACT

A sod mat easily transportable to a selected site and laid out as a lawn. The sod mat has mesh and sprouted grass plants with roots sufficiently intertwined with the mesh to form a movable sod mat. The mesh has a multiplicity of holes. Each hole is sized and shaped so that roots can grow through the mesh but seeds do not fall through the mesh. The sod mats may include synthetic soil over the mesh, with the sprouted grass plants interspersed throughout. This invention also includes an apparatus and method for producing such sod mats

### BACKGROUND

1. Field of the Invention

This invention relates to an improved mesh backed lawn sod and a method and apparatus for producing the same.

2. State of the Art

Many gardeners grow lawns from sod mats. In the prior art, sod was grown outdoors in grass fields. After the grass had sprouted and reached a suitable growth, harvesters cut the grass from the ground and into sod mats. These sod mats were transportable. Gardeners laid out these sod mats over suitably prepared soil to produce an instant lawn.

In the grass fields, it took almost a year after the seeds were sown for the grass roots to intertwine so that the sod mat would hold together during transport. Gardeners discovered that putting half-inch string netting over the soil could reduce this time to six months. Still, the mats produced were heavy and difficult to handle. Because these sod mats were grown outdoors, weeds and other pests could infect the grass. The health and growth time of the sod mats were subject to weather. A need existed for lighter sod mats that could be more quickly grown and that was protected from pests and poor weather.

About fifteen years ago, James Lars Anderson developed sod mats that were lighter and more easily produced than the prior art. The sod was produced by placing a mixture of peat moss and grass seed over a fine mesh of polyethylene fabric such as Claf®. With the use of the mesh, the sod mats were transportable after seven days, rather than after six months to a year. This sod mat was grown in a greenhouse. In 1986, investors started to produce and market this invention but Anderson never applied for a patent. A local newspaper wrote an article describing this invention. Since that time, however, Anderson both improved the sod mats and the method for producing the same. Anderson also invented an apparatus to produce these mats. These improvements and the apparatus are the subjects of this specification and claims.

One problem that Anderson faced with his prior invention was peat moss infection. Anderson discovered that peat moss contained bacteria and fungi that can infect new grass, destroying an entire greenhouse full of grass. Anderson saw a need to improve his earlier sod mats.

### SUMMARY OF THE INVENTION

It is an object of the invention to produce a sod mat that is:

Lightweight and easily transportable.

Grown away from weeds and other pests.

Transportable seven days after the grass seeds are sown.

Not subject to bacteria and fungus infections.

It is another object of the invention to provide a method for producing sod mats that is quicker and less labor intensive than other methods.

It is an additional object of the invention to provide an apparatus for producing sod mats quickly, efficiently, and sanitarily.

These objects are realized through a sod mat containing sprouted grass plants grown from grass seeds. The sod mat is transportable to a selected site and laid out as a lawn. The sod mat has mesh and sprouted grass plants with roots sufficiently intertwined with the mesh to form a movable sod mat. The mesh has a multiplicity of holes. Each hole is sized and shaped so that roots can grow through the mesh but seeds do not fall through the mesh. The sod mats may include synthetic soil over the mesh, with the sprouted grass plants interspersed throughout the synthetic soil.

This invention also includes a method for producing sod mats that can be transported to a site and laid out as lawn. The method includes the steps of placing seeds on a sheet of mesh and keeping the seeds moist until the seeds sprout roots that intertwine with the mesh. This forms a sod mat that can be transported to a site and laid out as a lawn. The mesh has a multiplicity of holes. The holes are sized and shaped so that roots can grow through the mesh but seeds will not fall through the mesh. In one embodiment, the seeds are keep moist by mixing seeds in a synthetic soil, spreading the mixture of seeds and synthetic soil on the mesh, and keeping the synthetic soil moist.

This invention also includes an apparatus for producing sod mats. The method includes means to mix the seeds with the synthetic soil, an applicator to apply the mixture of seeds and synthetic soil over the mesh, and a harvester to prepare the sod mats with sprouted grass plants for transport.

### BRIEF DESCRIPTION OF THE DRAWINGS

FIG. 1 shows cut-a-way perspective view of a sod mat.

FIG. 2 shows details of the mesh and seeds of the sod mat in FIG. 1.

FIG. 3 shows a perspective view of an apparatus for preparing the sod mats of FIG. 1.

FIG. 4 shows a perspective view of a batch plant.

FIG. 5 shows a perspective view of an applicator and a harvester working in conjunction to roll up a first sod mat and lay a second sod mat on a shelf

FIG. 6 shows further details of the applicator in FIG. 5.

### DETAILED DESCRIPTION

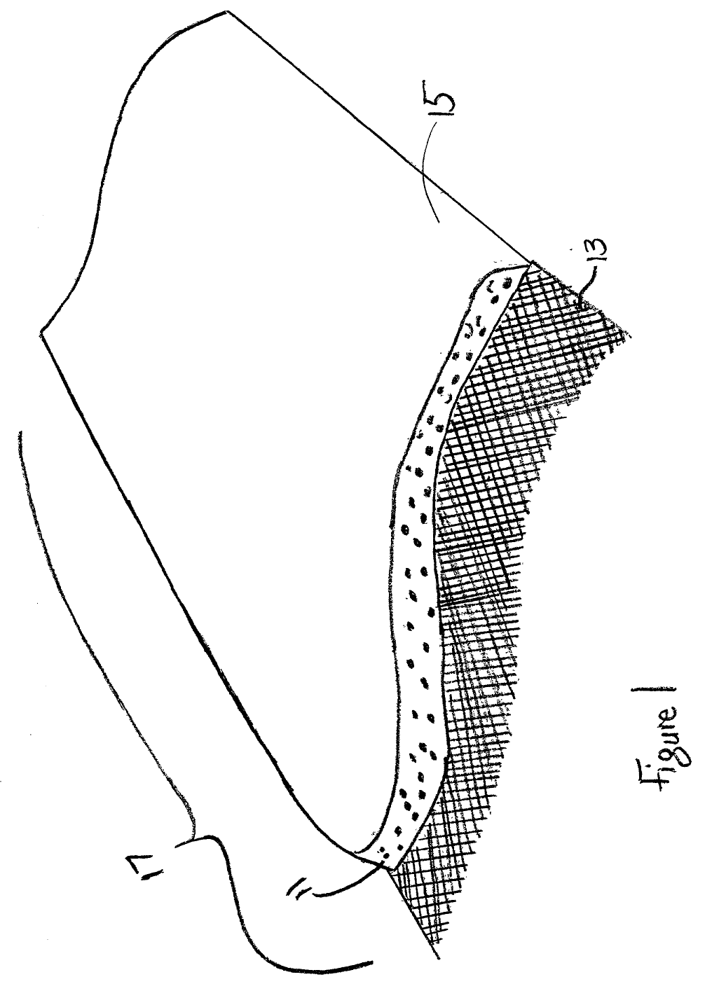

As shown in FIG. 1, a sod mat 17 includes a fine mesh material 13. Above the mesh are grass seeds 11 mixed in a synthetic soil 15. An example of such synthetic soil includes Hydro Mulch®, a paper mulch. Wood fiber synthetic soils are also available. The purpose of the soil is to keep the seeds moist while they are germinating. Synthetic soil may include peat moss, but only if the peat moss has been sterilized to kill any natural bacteria, virus, fungi, or other pests. Peat moss grows in bog ponds which often contain many such pests. Sterilized peat moss is now available. As used in the claims, the term synthetic soil excludes unsterilized or untreated peat moss. In one embodiment of the invention, no soil is used. Sprinklers or other means keep the seed moist until the roots sprout and intertwine with the mesh.

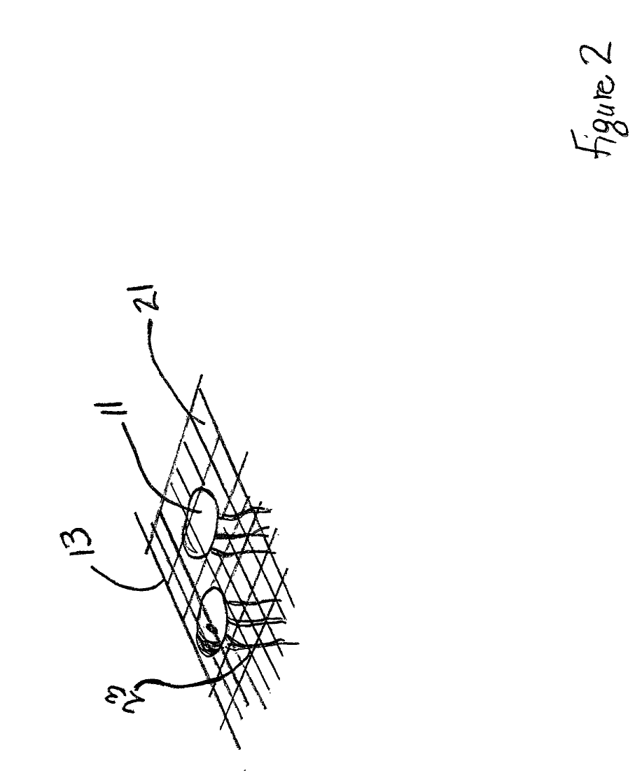

FIG. 2 shows details of the mesh 13 and seeds 11 that form the sod mat in FIG. 1. The mesh has a multiplicity of holes 21. The holes are sized and shaped so that grass roots 23 can grow through the mesh but the grass seeds and the synthetic soil do not fall through the mesh. In one embodiment, the mesh is a polyethylene fabric such as Claf®. Claf® is a non-woven polyethylene fabric used in the manufacture of reinforced papers, films, and foamed sheets. Nippon Petrochemicals Co, LTD, markets Claf®. Except as discussed in the information disclosure documents filed with the U.S. Patent and Trademark Office in support of this specification, polyethylene fabric such as Claf® has never been used in the prior art for lawns.

Polyethylene fabrics may be biodegradable or non-biodegradable. For environmental purposes, the mesh should be biodegradable. In a few selected applications, however, such as putting greens for golf courses, the mesh may be non-biodegradable. This would allow easy replacement of divots and other damage to the green.

Grass seeds need seven days to sprout roots that sufficiently intertwine with the mesh. Once the roots sufficiently intertwine with mesh, the sod mat can be moved. This compares favorably to the six months to a year required by prior art sod mats. Obviously, this has benefits over the prior art because many more mats can be produced in a smaller area with less water, fertilizer, labor, and pollution. Moreover, because a seed contains its own food supply, grass seeds will germinate in the first twenty-one days with only a little indirect sun and moisture. Since grass seeds require no direct sunlight or fertilizer during this time, the improved sod mats can be raised in a greenhouse with no fertilizer. The short time needed for the roots to intertwine with the mesh also allows the use of a synthetic soil with little or no nutrient value or the use of no soil at all. As noted above, the sole purpose of soil is to keep the seeds moist while they are germinating. Because the mats avoid heavy dirt, the sod mat in the present invention is much more lightweight than prior art sod mats. These sod mats are more easily transported than the prior art.

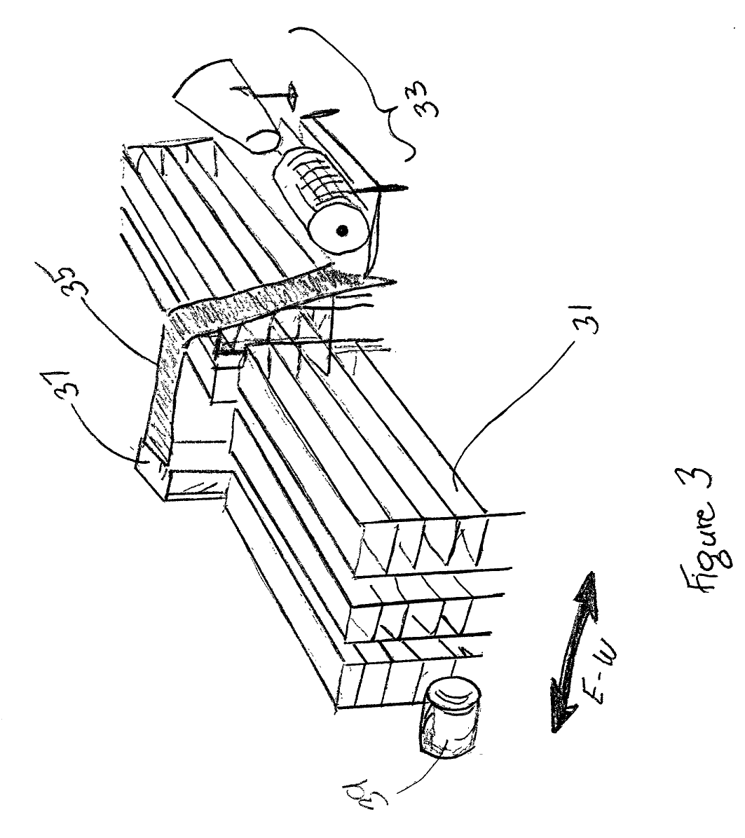

As shown in FIG. 3, the sod mats are grown on shelves 31 in a greenhouse. The greenhouse protects the new sod from weeds and other pests and also allows control of temperature and humidity. A temperature near 70° F. to 80° F. and a humidity about 80% to 90% produces the best germination results. With a properly maintained temperature and humidity, more of the grass seeds germinate. In grass fields, about 60% to 70% of the individual grass seeds germinate. In a properly controlled greenhouse, about 85% of the grass seeds germinate. In such controlled environment, however, invasive spores may easily breed disease. Thus, the greenhouse must protect the young grass seeds from the outside environment.

Each sod mat is generally shaped and sized to fit a shelf, with each shelf and each sod mat being about a four by fifty-foot rectangle. As shown by the double arrow E-W, the greenhouse is oriented generally in an east-west direction with the length of the shelves generally oriented in a north-south direction. This allows a more even distribution of the sunlight over each shelf so that the entire mat grows at an even rate.

A batch plant 33 mixes and shifts the seeds with the synthetic soil. A conveyer belt 35 moves the mixed and shifted synthetic soil and seeds moves to an applicator 37. The applicator evenly distributes the synthetic soil seed mixture over a four by fifty foot length of mesh. A harvester 39 rolls up sprouted grass sod mats for shipping and pulls new mesh onto the shelf. While the harvester pulls the new mesh, the applicator applies synthetic soil and seed mixture on the mesh. The controls for the batch plant, conveyer belt, applicator, and harvester are co-located near the harvester to allow the operator to assist in rolling the sprouted grass mats while controlling the distribution of the synthetic soil seed mixture.

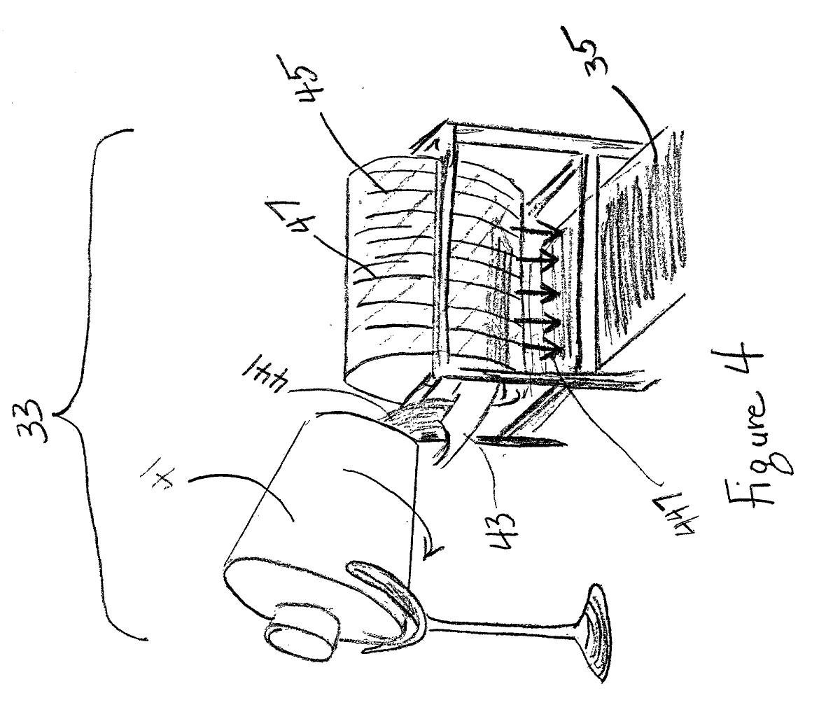

As shown in detail in FIG. 4, the batch plant 33 includes a mixer 41 to mix the seeds with the synthetic soil. An operator loads the mixer with synthetic soil and seed. The mixer rotates and vibrates to sufficiently mix the synthetic soil with the seeds. The mixed soil and seeds 441 pours into a trough 43 that funnels the soil and seeds into a first shifter 45. The first shifter is generally cylindrical with a skin of firm metallic or hard plastic mesh 47. The first shifter retains any large pieces of soil but sprinkles the proper sized mix of soil and seeds 447 on the conveyer belt 35. As shown in FIG. 3, the conveyer belt carries the mixed and shifted soil and seeds to the applicator 37.

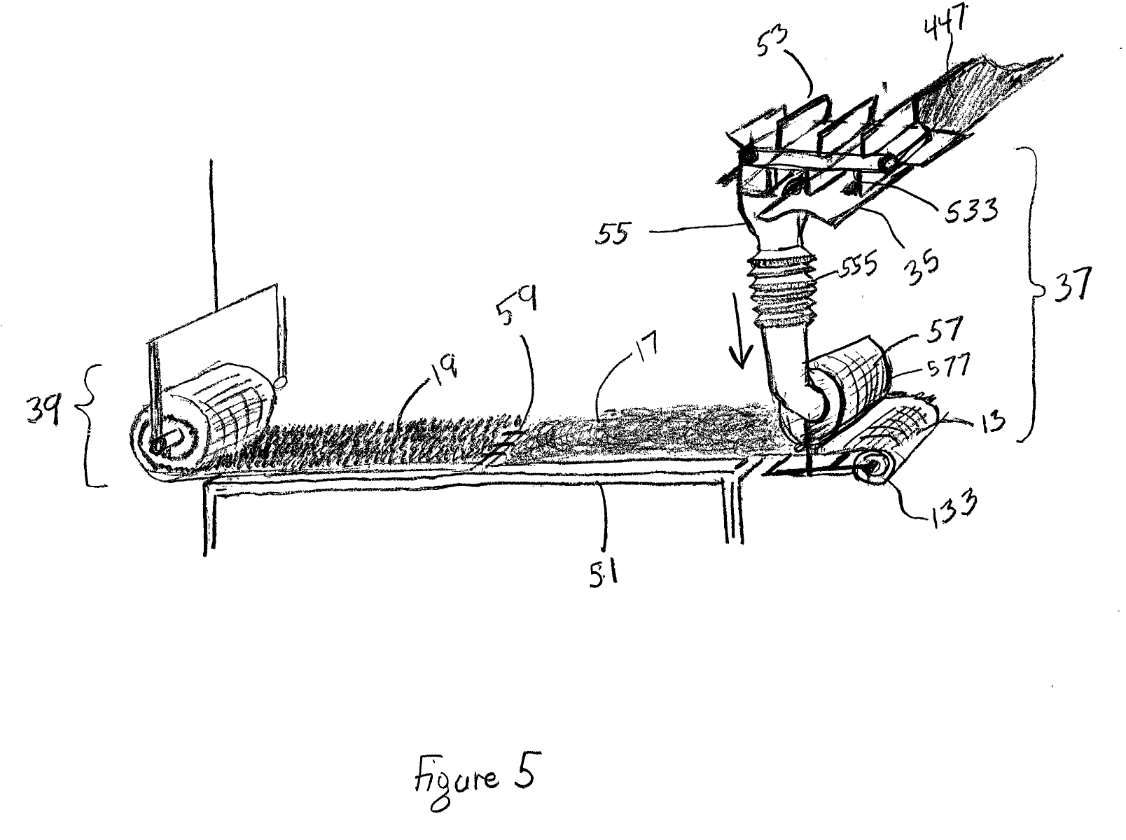

FIG. 5 shows the details of the applicator 37 and the harvester 39 working in conjunction to simultaneously remove an old sod mat with sprouted grass plants 19 and lay a new sod map 17 on a shelf 51. The conveyer belt 35 moves the premixed soil and seeds 447 to the applicator 37. Paddles 53 on the applicator scrap the premixed soil and seeds off the conveyer belt into a chute 55. The paddles in FIG. 5 are on a small second conveyer belt 533 but those skilled in the art could devise several different designs that could scrape the premixed soil and seeds into the chute. The height of the chute 55 is adjustable, here shown with an accordion neck 555. The accordion neck allows the height of the chute to be adjusted for different heights of shelves. Both the applicator 37 and the harvester 39 move along the rows of shelves so that only one applicator and harvester are needed to service a number of shelves.

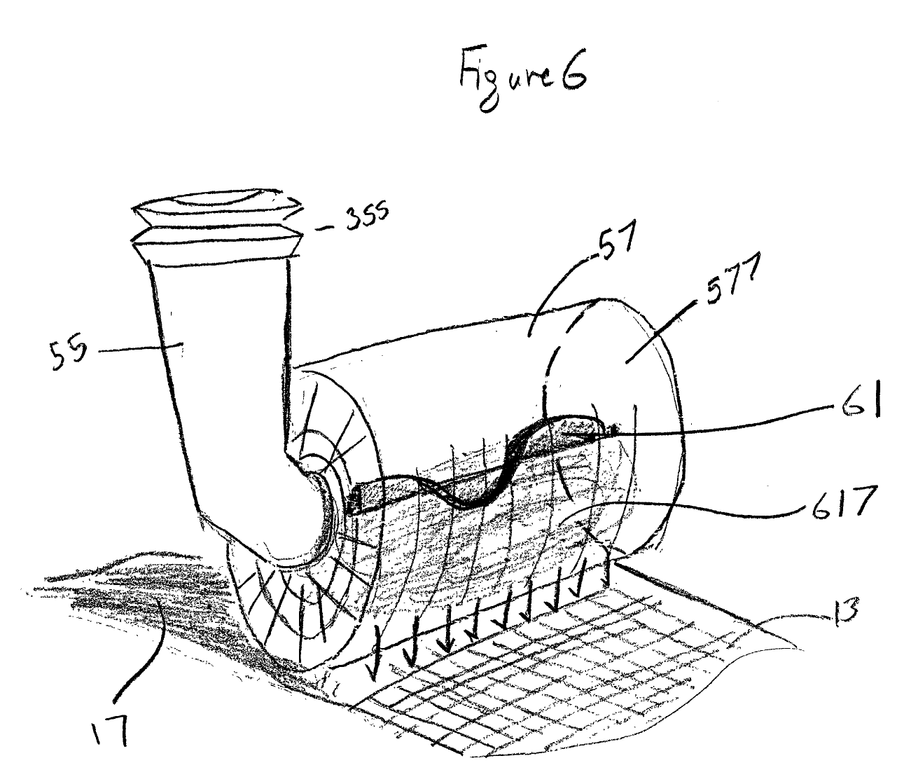

The chute 55 funnels the premixed soil into a second shifter 57. Similar to the first shifter on the batch plant, the second shifter is generally cylindrical with a skin of firm metallic or hard plastic mesh 577. Unlike the first shifter, however, the purpose of the second shifter is to evenly apply the premixed soil on the mesh. As shown in FIG. 6, an auger 61, inside the second shifter, assists in spreading the premixed soil 617 evenly through the second shifter. The premixed soil drops onto the mesh 13.

As shown in FIG. 5, the harvester 39, using either mechanical or operator power, rolls up the sod mat with sprouted grass plants 19. Temporary connectors 59 link the sod mat with the sprouted grass plants to the new sod mat 17 so, as the old mat is rolled up, the new mat is pulled onto the shelf 51. As the new mat is pulled onto the shelf, new mesh is unrolled from a roll of mesh 133 located near the second shifter. The applicator applies the premixed synthetic soil and seeds to the top surface of the mesh. Thus, the harvester simultaneously rolls up the old mat while up rolling out the new. When the old mat is completely rolled up, the operator disconnects the temporary connectors 59 and cuts the desired length of mesh 13 from the roll 133.

The above-described arrangements are only illustrative of the application of the principles of the present invention. Many modifications and alternative arrangements may be devised by those skilled in the art without departing from the spirit and scope of the present invention. The appended claims are intended to cover such modifications and arrangements.

I claim:

1. A sod mat with sprouted grass plants grown from grass seeds, the sod mat being transportable to a selected site and laid out as a lawn, the sod mat comprising:
mesh, the mesh having a multiplicity of holes, the holes being sized and shaped so that roots can grow through the mesh but seeds do not fall through the mesh; and
sprouted grass plants with the roots sufficiently intertwined with the mesh to form a movable sod mat.

2. The sod mat of claim 1, further containing synthetic soil over the mesh, with the sprouted grass plants interspersed throughout.

3. The sod mat of claim 2, wherein the synthetic soil is paper mulch.

4. The sod mat of claim 2, wherein the synthetic soil is wood fiber mulch.

5. The sod mat of claim 2, wherein the synthetic soil is sterilized peat moss.

6. The sod mat of claim 1, wherein the mesh is polyethylene fabric.

7. The sod mat of claim 1, wherein the mesh is Claf®.

8. The sod mat of claim 1, wherein the mesh is biodegradable.

9. The sod mat of claim 1, wherein the mesh is non-biodegradable.

10. A method for producing sod mats that can be transported to a site and laid out as lawn, the method comprising:
placing seeds on a sheet of mesh, the mesh having a multiplicity of holes, the holes being sized and shaped so that roots can grow through the mesh but seeds will not fall through the mesh; and
keeping the seeds moist until the seeds sprout roots that intertwine with the mesh, forming a sod mat that can be transported to a site and laid out as a lawn.

11. The method of claim 10, wherein the seeds are keep moist by:
mixing seeds in a synthetic soil;
spreading the mixture of seeds and synthetic soil on the mesh; and
keeping the synthetic soil moist.

12. The method of claim 10, wherein the method includes the step of protecting the seeds from the outside environment while they are spouting.

13. The method of claim 12, wherein the step of protecting the seeds is growing the mats in a greenhouse.

14. The method of claim 10, wherein the temperature is keep at 70° F. to 80° F. and the humidity is keep at about 80% to 90% while the seeds are germinated.

15. An apparatus for producing sod mats, the sod mats each containing sprouted grass plants grown from un-sprouted grass seeds, the sod mat being transportable to a selected site and laid out as a lawn, the sod comprising mesh, the mesh having a multiplicity of holes, the holes being sized and shaped so that grass roots can grow through the mesh but seeds do not fall through the mesh; a layer of synthetic soil over the mesh; and sprouted grass plants interspersed throughout the synthetic soil, the apparatus comprising:
means to mix the un-sprouted seeds with synthetic soil;
an applicator to apply the mixture of seeds and synthetic soil over the mesh; and
a harvester to prepare the sod mats with sprouted grass plants for transport.

16. The apparatus of claim 15 wherein the seeds are allowed to sprout in a controlled environment with a temperature of 70° F. to 80° F. and a humidity of 80% to 90%.

17. The apparatus of claim 15 wherein the apparatus further consists of shelves to hold the mixture of seeds and synthetic soil over the mesh until the seed's roots sprout and sufficiently intertwine through the mesh to produce a transportable sod mat.

18. The apparatus of claim 15 wherein the apparatus further consists of means to move the mixture of un-sprouted seeds and synthetic soil from the means to mix the seeds and the synthetic soil to the applicator.

19. The apparatus of claim 15 wherein the means to mix the un-sprouted seeds with synthetic soil further includes a means to shift the soil and un-sprouted seeds to remove any large clumps of synthetic soil.

20. The apparatus of claim 17 wherein the harvester to prepare the sod mats with sprouted grass plants for transport further includes means to pull new mesh covered with the mixture of synthetic soil and un-sprouted seeds onto the shelves.
